(19) United States
(12) Patent Application Publication
(10) Pub. No.: US 2017/0306164 A1
(43) Pub. Date: Oct. 26, 2017

(54) MATTE COATING COMPOSITION

(71) Applicant: LG Hausys, Ltd., Seoul (KR)

(72) Inventors: Min-Chang JO, Seoul (KR); Won-Kook KIM, Daejeon (KR)

(21) Appl. No.: 15/510,232

(22) PCT Filed: Aug. 31, 2015
(86) PCT No.: PCT/KR2015/009139

§ 371 Date: Mar. 9, 2017

(30) Foreign Application Priority Data
Sep. 12, 2014 (KR) 10-2014-0121343

(51) Int. Cl. C09D 5/00; C09D 7/12; C09D 175/04

(52) U.S. Cl. CPC C09D 5/006; C09D 175/04; C09D 7/1275; C09D 7/1283

(57) ABSTRACT

Provided is a matte coating composition including: a binder resin; inorganic particles; and organic particles, a wax-based dulling agent, or a silica-based dulling agent. Provided is an interior material for a vehicle, including: a base layer; and a matte coating layer formed of the matte coating composition.

### TECHNICAL FIELD

The present invention relates to a matte coating composition.

### BACKGROUND ART

Surface treatment is carried out on articles to protect surfaces and improve appearance thereof, such as plastics, household appliances, furniture, vehicles, etc.

The articles are variously surface-treated depending on the use and design of products. In some cases, a high-gloss surface treatment may be carried out, and a matte surface treatment may be carried out.

In addition, a coating agent used for the surface treatment of the articles is required to have various performances such as resistance against scratches (scratch resistance) caused by sand and dust, a nature that is not chemically modified against an acid rain (acid resistance), a nature that is not damaged by organic solvents such as gasoline (solvent resistance), etc. In addition, sufficient moldability also has to ensure so that the coating agent can be applied uniformly and stably on the surfaces of the articles.

For matte surface treatment on the surface of an article, a coating agent is used so that the surface of the article has a very low gloss of 5% or less. To this end, the coating agent is prepared by including additives such as silica, calcium carbonate, etc., as dulling agents.

However, the additives such as silica, calcium carbonate, etc., have problems in that surface roughness is increased at the time of curing the coating agent, uneven glossiness phenomenon is caused, and stain resistance of a surface coated with the coating agent is reduced. Particularly, the coating agent including the silica as the additive has a nature that foreign substances such as ink, coffee, tea, etc., are strongly adsorbed on the surface of silica, and thus, there is a problem in that the stain resistance is remarkably deteriorated.

Therefore, what is required is a coating composition that exhibits an uniform matte effect generally and has excellent stain resistance when applied to the articles.

### DISCLOSURE

### Technical Problem

It is an aspect of the present invention to provide a matte coating composition including: inorganic particles, and organic particles, a wax-based dulling agent, or a silica-based dulling agent to secure a matte effect and a soft texture effect at the same time.

It is another aspect of the present invention to provide an interior material for a vehicle, including: a matte coating layer formed of the matte coating composition.

### Technical Solution

In accordance with one aspect of the present invention, a matte coating composition includes: a binder resin; inorganic particles; and at least one selected from organic particles, a wax-based dulling agent, and a silica-based dulling agent. About 1 to about 10 parts by weight of the inorganic particles; and about 5 to about 30 parts by weight of the at least one selected from the organic particles, the wax-based dulling agent, and the silica-based dulling agent may be included based on 100 parts by weight of the binder resin.

The inorganic particle may include silica particles having a particle diameter of about 0.5 μm to about 15 μm.

The organic particle may include one or more selected from the group consisting of an acrylic resin, a polyurethane resin, a polystyrene resin, and a combination thereof, and may have a particle diameter of about 0.5 μm to about 10 μm.

The wax-based dulling agent may include one or more selected from the group consisting of polyethylene, polypropylene, polytetrafluoroethylene, and a combination thereof, and may have a particle diameter of about 0.5 μm to about 100 μm.

The silica-based dulling agent may be one or more selected from the group consisting of silica rubber powder, silicone resin powder, silicone mixed powder, and a combination thereof.

The silicone rubber powder may have a structure in which straight-chain dimethylpolysiloxanes are cross-linked, and may have a particle diameter of about 1 μm to about 30 μm.

The silicone resin powder may have a structure in which siloxane bonds are cross-linked in a three-dimensional network structure, and may have a particle diameter of about 0.2 μm to about 8 μm.

The silicone mixed powder may include organic particles having silicone resin powder protrusions formed on a surface thereof.

The silicone mixed powder may be formed by coating the organic particles with the silicone resin powder, and may have a particle diameter of about 0.5 μm to about 20 μm.

The binder resin may be one or more formed from the group consisting of a water-dispersible polyurethane resin, an acrylic resin, a polyester resin, and a combination thereof.

In accordance with another aspect of the present invention, an interior material for a vehicle includes: a base layer; and a matte coating layer formed of the matte coating composition.

A glossiness of the matte coating layer at 60 degrees may be about 2 or less, the glossiness being measured by a BYK (Micro-TRI-gloss) gloss meter.

The matte coating layer may have a standard deviation of a surface friction coefficient of about 0.5 or less.

The base layer may include one or more selected from the group consisting of a polyvinyl chloride resin, a polyurethane resin, a polylactic acid resin, and a combination thereof.

### Advantageous Effects

The matte coating composition may realize a matte effect and a soft texture effect at the same time.

The interior material for a vehicle may have improved chemical resistance, stain resistance, etc., to be utilized even with a bright color.

### DESCRIPTION OF DRAWINGS

FIG. 1 is a graph relating to a method for calculating a standard deviation of a surface friction coefficient (Squeak index).

### BEST MODE

Hereinafter, exemplary embodiments of the present invention will be described in detail. However, these exemplary embodiments are only provided by way of example, and the present invention is not limited thereto, but may be defined by the scope of the appended claims.

Matte Coating Composition

In an exemplary embodiment of the present invention, the present invention provides a matte coating composition including: a binder resin; inorganic particles; and at least one selected from organic particles, a wax-based dulling agent, and a silica-based dulling agent.

In general, a matte surface is realized by coating synthetic leather for automobile interior materials with a coating composition including silica particles.

However, when the coating composition includes an excessive amount of silica particles in order to express a matte effect on the synthetic leather for automobile interior materials, the particles may be exposed on a surface of a coating layer due to characteristics of the silica particles, and thus, stain resistance may be hindered, and it may be difficult to realize a soft texture.

Accordingly, the matte coating composition includes a reduced content of inorganic particles, and includes the organic particles, the wax-based dulling agent or the silica-based dulling agent, replacing the reduced inorganic particles, such that a dulling effect obtained by an extinction interference phenomenon of light due to a difference in refractive index among the binder resin, the inorganic particles, the organic particles, and the dulling agent may be improved, thereby realizing the matte surface. In addition, the soft texture may be maintained by reducing the content of the inorganic particles.

Specifically, the matte coating composition may include the binder resin, and may include the organic particles, the wax-based dulling agent, or the silica-based dulling agent, in addition to the inorganic particles.

The matte coating composition may include about 1 to about 10 parts by weight of the inorganic particles; and about 5 to about 30 parts by weight of the at least one selected from the organic particles, the wax-based dulling agent, and the silica-based dulling agent, based on 100 parts by weight of the binder resin.

The conventional matte coating composition includes about 15 to 20 parts by weight of the inorganic particles based on 100 parts by weight of the binder resin. However, in this case, since the soft texture may not be expressed by the inorganic particles, users are not able to have a soft touch feeling.

On the other hand, the matte coating composition includes about 1 to about 10 parts by weight of the inorganic particles based on 100 parts by weight of the binder resin, such that the dulling effect may be easily implemented, while simultaneously not hindering the soft texture. In detail, when the inorganic particles have a content of less than about 1 part by weight, anti-blocking property may be deteriorated. When the inorganic particles have a content of more than about 10 parts by weight, the soft texture may be hindered and surface friction may be increased.

In addition, the matte coating composition may include the at least one selected from the organic particles, the wax-based dulling agent, and the silica-based dulling agent, replacing the reduced inorganic particles. When the at least one selected from the organic particles, the wax-based dulling agent, and the silica-based dulling agent has a content of more than about 30 parts by weight based on 100 parts by weight of the binder resin, dispersibility of the particles may be deteriorated. When the at least one selected from the organic particles, the wax-based dulling agent, and the silica-based dulling agent has a content of less than about 5 parts by weight, there is a problem in that it is difficult to express the matte effect. For example, it is preferred that when the at least one selected from the organic particles, the wax-based dulling agent, and the silica-based dulling agent has a content of about 7 parts by weight to about 15 parts by weight based on the binder resin, the dulling effect may be implemented together with realization of the soft texture.

The inorganic particles are dulling agents, and are able to realize the dulling effect by diffused reflection of the inorganic particles themselves. For example, the inorganic particles may be barium sulfate, silicon dioxide, calcium carbonate, titanium dioxide, talc, antimony trioxide, silica particles, etc.

Here, it is advantageous to use the silica particles since the dulling effect is able to be economically exhibited. The inorganic particles may include the silica particles having a particle diameter of about 0.5 μm to about 15 μm. The ‘particle diameter’ refers to an ‘average particle diameter’, which means an average value of diameters measured in any region of the particles. In detail, when the particle diameter of the silica particles is less than about 0.5 μm, a thickness of the matte coating layer to be described below may not be satisfied, such that the anti-blocking property may be deteriorated. When the particle diameter of the silica particles is more than about 15 μm, the soft texture may be reduced and the surface friction may be increased.

The organic particles may include one or more selected from the group consisting of an acrylic resin, a polyurethane resin, a polystyrene resin, and a combination thereof, and may have a particle diameter of about 0.5 μm to about 100 μm.

The organic particles are spherical, which is preferred in realization of the soft texture. However, there are limitations in realizing the matte effect when the organic particles are used alone, and thus, the organic particles may be mixed with silica inorganic particles, thereby easily forming the coating layer of the matte surface.

For example, the acrylic resin particles may implement the dulling effect by light diffusion due to the difference in refractive index with the water-dispersible polyurethane resin, but may be disadvantageous in securing soft feeling and abrasion resistance due to insufficient elasticity. On the other hand, the polyurethane resin particles may have excellent elasticity, and realize a moist feeling like natural leather, and thus, they are usable for interior materials for vehicle in which natural leather and synthetic leather are used.

The wax-based dulling agent may include one or more selected from the group consisting of polyethylene, polypropylene, polytetrafluoroethylene, and a combination thereof, and may have a particle diameter of about 0.5 μm to about 100 μm. Further, polyamide, carnauba wax, candelilla wax, rice wax, petrolatum, etc., may be used as the wax-based dulling agent.

Specifically, when the particle diameter of the wax-based dulling agent is less than about 0.5 μm, particles not contributing to the matte effect are increased in the matte coating layer, and thus, the wax-based dulling agent is required to be added in an excessive amount. In this case, it is easy to aggregate the wax-based dulling agent, and thus, dispersibility may be deteriorated, smoothness of the surface of the matte coating layer may be hindered, and viscosity of the coating composition may be increased. Meanwhile, when the particle diameter of the wax-based dulling agent is more than about 100 μm, since the smoothness of the matte coating layer may be reduced, the wax-based dulling agent may easily precipitate during the coating process, and thus, it may be difficult to obtain a uniform matte coating layer.

When the wax-based dulling agent is used alone, dulling property may be deteriorated. However, when the wax-based dulling agent is mixed with the inorganic particles or organic particles, surface slip property and solvent resistance are improved, such that it is advantageous to improve the stain resistance and to realize the soft texture. In addition, when the above-described contents are maintained, the matte coating composition has improved flowability, which is advantageous in coating operation.

A specific gravity of the wax-based dulling agent may vary depending on each constitution thereof, but an average specific gravity thereof may be about 0.7 to about 2.3, specifically, about 0.8 to about 1.2.

In addition, a softening point of the wax-based dulling agent may vary depending on each constitution, but an average softening point may be about 70° C. to about 320° C. When the softening point of the wax-based dulling agent is less than about 70° C., the wax-based dulling agent may soften during a drying process to reduce the matte effect of the matte coating layer. When the softening point thereof is more than about 250° C., it is difficult to control the particle diameter, and thus, it is difficult to realize the matte effect of the matte coating layer.

The silica-based dulling agent may be one or more selected from the group consisting of silica rubber powder, silicone resin powder, silicone mixed powder, and a combination thereof.

The silica-based dulling agent mainly consists of silica (SiO₂), and when the silica-based dulling agent is used in a large content, the matte effect may be realized, but the surface may be rough. Accordingly, it is advantageous to maintain the above-described range of content when using the silica-based dulling agent. The composition may include the silica-based dulling agent, thereby exhibiting the stain resistance.

The silicone rubber powder may have a structure in which straight-chain dimethylpolysiloxanes are cross-linked, and may have a particle diameter of about 1 μm to about 30 μm. The silicone rubber powder has weather resistance, heat resistance and cold resistance as compared with general rubbers, and thus, elasticity is maintained in a wide temperature range, such that a soft and moist feeling may be realized.

Further, when the particle diameter is excessively small, cohesive force is increased, such that it has a difficulty in dispersion. Therefore, it is more advantageous to maintain the particle diameter within the above-described range in view of realization of the slip property and the soft texture.

The silicone resin powder may have a structure in which siloxane bonds are cross-linked in a three-dimensional network structure, and have a particle diameter of about 0.2 μm to about 8 μm.

In detail, the silicone resin powder has a powder form of polymethylsilsesquioxane, and is superior in heat resistance as compared to general silicone resins, and has a structure in which siloxane bonds are cross-linked in a three-dimensional network structure, such that it is not dissolved or expanded in alcohol-based, ketone-based, and ester-based organic solvents, and thus, has excellent solvent resistance.

Further, it is possible to realize matte property, slip property, and abrasion resistance by maintaining the particle diameter of the silicone resin powder within the above-described range.

The silicone rubber powder maintains soft touch due to elasticity. On the other hand, the silicone resin powder is a rigid material having no elasticity, and may improve the slip property. Further, since the refractive index of the silicone resin powder is different from that of the binder resin, light diffusion property may be imparted to improve the matte effect.

The silicone mixed powder may include organic particles having silicone resin powder protrusions formed on a surface thereof.

The silicone mixed powder is formed by coating the organic particles with the silicone resin powder. For example, protrusions of polymethylsilsesquioxane may be formed on the surface of the polyurethane resin particles by coating the polyurethane resin particles with polymethylsilsesquioxane.

In addition, the particle diameter of the silicone mixed powder may be about 0.5 μm to about 20 μm. It is advantageous to maintain the particle diameter within the above-described range in view of realization of the matte effect, the anti-blocking property, and abrasion resistance.

The silicone mixed powder has a mixture form of the organic resin and the silicone resin powder. The silicone mixed powders do not aggregate with each other, such that it is possible to have excellent dispersibility and to realize soft touch.

Further, the matte coating composition may further include conventional additives such as an isocyanate curing agent, an epoxy curing agent, a viscosity modifier, a defoaming agent, and a leveling agent, etc. A content of the additive is not limited as long as it does not affect properties of the composition. For example, the additive may have a content of 0.1 part by weight to 10 parts by weight based on 100 parts by weight of the binder resin.

The binder resin may be one or more formed from the group consisting of a water-dispersible polyurethane resin, an acrylic resin, a polyester resin, and a combination thereof. The inorganic particles, the organic particles, the wax-based dulling agent or the silica-based dulling agent are dispersed in the binder resin, thereby simultaneously realizing the matte effect and the stain resistance.

In detail, the water-dispersible polyurethane resin is formed by synthesizing a polyol compound and an isocyanate compound, and may be formed by synthesizing polycarbonate diol, isophorone diisocyanate, and dimethylolpropionic acid.

The water-dispersible polyurethane resins are different in properties depending on combinations of polyol components, and may realize heat resistance, cold resistance, abrasion resistance, flexibility, workability, flexibility, chemical resistance, and durability, etc., required for interior materials for vehicle. The water-dispersible polyurethane resin is excellent in adaptability to various processing methods, such that it is used to manufacture films, sheets and various molded articles as binders of synthetic artificial leather materials, various coating agents, inks, paints, etc.

Interior Material for Vehicle

In an another exemplary embodiment of the present invention, the present invention provides an interior material for a vehicle including: a base layer; and a matte coating layer formed of the matte coating composition.

The matte coating layer is formed by the matte coating composition, and the matte coating composition is as described above.

By applying and drying the matte coating composition on the base layer, it is possible to realize a matte effect of the interior material for a vehicle, thereby allowing the consumer to feel soft touch and texture. Further, the matte coating composition includes the organic particles, the wax-based dulling agent, or the silica-based dulling agent, in addition to the inorganic particles, thereby improving stain resistance, such that when the base layer of a light color is used, it is possible to maximize the stain resistance effect.

A glossiness of the matte coating layer at 60 degrees may be about 2 or less, the glossiness being measured by a BYK (Micro-TRI-gloss) gloss meter. The matte coating layer is formed of the matte coating composition including a predetermined content of the at least one selected from the organic particles, the wax-based dulling agent, and the silica-based dulling agent, in addition to the inorganic particles, and thus, about 2 or less of the glossiness may be exhibited while simultaneously realizing the soft texture, thereby realizing the matte surface of the interior material for a vehicle.

The matte coating layer may have a standard deviation of a surface friction coefficient of 0.5 or less. As the average deviation of the surface friction coefficient is smaller, the matte coating layer realizes a more soft texture. Regarding this, a method for measuring the average deviation of the surface friction coefficient is described below.

The base layer may include conventional natural leather, or synthetic leather, used as the interior materials for vehicle. For example, the base layer may be one or more formed from the group consisting of polyvinyl chloride, polyurethane, polylactic acid, and a combination thereof.

Hereinafter, specific Examples of the present invention will be provided. Meanwhile, Examples to be described below are just provided for specifically exemplifying or explaining the present invention, and accordingly, the present invention is not limited to the following Examples.

### Examples and Comparative Examples

### Example 1

A matte coating composition was prepared by mixing 8 parts by weight of silica particles having a particle diameter 5 μm, 10 parts by weight of a silicone resin powder having a particle diameter of 2 μm, 5 parts by weight of an isocyanate compound as a crosslinking agent, 1 part by weight of a silicone-based resin as a leveling agent, 1 part by weight of hydrophobically modified polyethylene oxide urethane (HEUR) as a viscosity modifier, and 0.5 parts by weight of a silicone-based resin as a defoaming agent, based on 100 parts by weight of a water-dispersible polyurethane resin.

The matte coating composition was applied to a polyvinyl chloride resin layer at a thickness of 5 μm, followed by drying, to form a matte coating layer to manufacture an interior material for a vehicle.

### Example 2

An interior material for a vehicle was manufactured in the same manner as in Example 1 except that the silicone resin powder was replaced with 10 parts by weight of polyurethane resin particles having a particle diameter of 5 μm.

### Example 3

An interior material for a vehicle was manufactured in the same manner as in Example 1 except that the silicone resin powder was replaced with 10 parts by weight of silicone mixed powder having a particle diameter of 5 μm.

### Comparative Example 1

An interior material for a vehicle was manufactured in the same manner as in Example 1 except that the silicone resin powder was not included.

### Comparative Example 2

An interior material for a vehicle was manufactured in the same manner as in Example 1 except that the silicone resin powder was not included, and 20 parts by weight of silica particles were included.

### <Experimental Example>—Physical Properties of Matte Coating Composition

1) Glossiness: A glossiness of the matte coating layers at 60 degrees in each of Examples and Comparative Examples was measured by a BYK (Micro-TRI-gloss) gloss meter.

2) Softness: A degree of softness was graded after touching the interior materials for vehicle of Examples and Comparative Examples. In Table 1, “Grade 5” indicated very soft, “Grade 4” indicated “soft”, “Grade 3” indicated normal, “Grade 2” indicated “rough”, and “Grade 1” indicated “very rough”.

3) Average deviation of surface friction coefficient (Squeak index): The matte coating layers of Example and Comparative Example were prepared as specimen 1 having a size of 500 mm (width)×200 mm (length) and specimen 2 having a size of 100 mm (width)×120 mm (length).

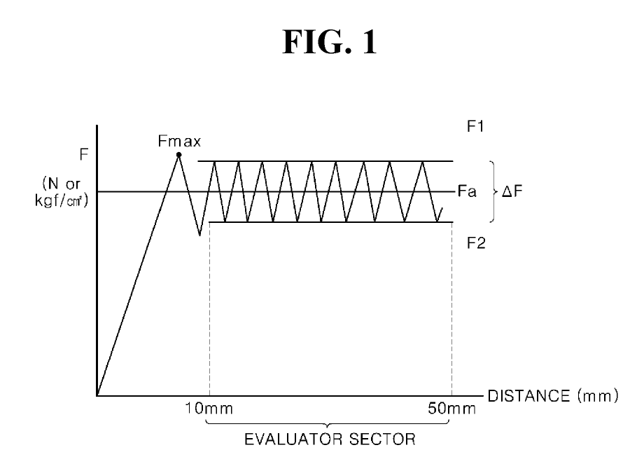

Then, the specimen 1 was placed on a friction pad having a size of 460 mm (width)×150 mm (length), and the specimen 2 was attached to a rubber having a size of 100 mm (width)×80 mm (length) and a weight of 4.5 kgf. Then, the specimens 1 and 2 were installed in a direction in which they contact each other, and moved by 40 mm or more at a speed of 300 mm/min, and then, a load was recorded, and an average deviation of surface friction coefficient was calculated by Equation below (see FIG. 1).

Average deviation of surface friction coefficient=ΔF/Fa [Equation]

Fa: Average force (kgf) required to pull the rubber,

ΔF (=F1−F2): Deviation of the force (kgf) required to pull the rubber within a moving distance

(F1: Maximum force required to pull the rubber, F2: Minimum force required to pull the rubber later)

4) Stain resistance: The interior materials for vehicle of Examples and Comparative Examples were prepared to specimens having a size of 25 mm (width)×220 mm (length), and general¹⁾ and denim²⁾ which were stain test fabrics were moved by 100 mm on the specimens at a speed of 30 times/minute, followed by 100 reciprocations with a load of 500 gf, and then, stain degrees were determined according to Grey scale (KSK 0910) and shown as grades. In Table 1, “Grade 5” indicated no stain, “Grade 3” indicated normal, and “Grade 2” indicated stain.

TABLE 1

| | | | | | Comparative | Comparative |
|---|---|---|---|---|---|---|
| | | Example 1 | Example 2 | Example 3 | Example 1 | Example 2 |
| Glossiness | | 1.5 | 1.9 | 1.5 | 4.0 | 2.5 |
| Softness | | 4 | 5 | 5 | 2 | 1 |
| Average deviation | | 0.3 | 0.5 | 0.2 | 0.8 | 1.2 |
| of surface friction | | | | | | |
| coefficient | | | | | | |
| Stain | General¹⁾ | 5 | 4 | 5 | 2 | 2 |
| resistance | Denim²⁾ | 4 | 3 | 4 | 2 | 2 |

¹⁾EPMA 106 (Cotton soiled with WC carbon black/mineral oil) manufactured by Testfabrics, Inc.
²⁾EPMA 128/1 (Cotton Jeans, indigo/sulfur black, soil with carbon black/olive oil) manufactured by Testfabrics, Inc.

Referring to Table 1 above, it could be appreciated that Comparative Examples 1 and 2 each including the matte coating layer formed by the matte coating composition including only the silica particles had a high glossiness and reduced softness as compared to those of Examples 1 to 3 each including the silicone resin powder, the polyurethane resin particles, and the silicone mixed powder, in addition to the silica particles.

Further, it was confirmed that the average deviation of surface friction coefficient of Examples 1 to 3 was measured to be 0.5 or less, while the average deviation of surface friction coefficient of Comparative Examples 1 and 2 exceeded 0.5. It was also confirmed in view of stain resistance that Examples 1 to 3 were excellent in removing stains.

1. A matte coating composition comprising:
a binder resin; inorganic particles; and
at least one selected from organic particles, a wax-based dulling agent, and a silica-based dulling agent.

2. The matte coating composition of claim 1, wherein 1 to 10 parts by weight of the inorganic particles; and 5 to 30 parts by weight of the at least one selected from the organic particles, the wax-based dulling agent, and the silica-based dulling agent are included based on 100 parts by weight of the binder resin.

3. The matte coating composition of claim 1, wherein the inorganic particle includes silica particles having a particle diameter of 0.5 μm to 15 μm.

4. The matte coating composition of claim 1, wherein the organic particle includes one or more selected from the group consisting of an acrylic resin, a polyurethane resin, a polystyrene resin, and a combination thereof, and has a particle diameter of 0.5 μm to 10 μm.

5. The matte coating composition of claim 1, wherein the wax-based dulling agent includes one or more selected from the group consisting of polyethylene, polypropylene, polytetrafluoroethylene, and a combination thereof, and has a particle diameter of 0.5 μm to 100 μm.

6. The matte coating composition of claim 1, wherein the silica-based dulling agent is one or more selected from the group consisting of silica rubber powder, silicone resin powder, silicone mixed powder, and a combination thereof.

7. The matte coating composition of claim 6, wherein the silicone rubber powder has a structure in which straight-chain dimethylpolysiloxanes are cross-linked, and has a particle diameter of 1 μm to 30 μm.

8. The matte coating composition of claim 6, wherein the silicone resin powder has a structure in which siloxane bonds are cross-linked in a three-dimensional network structure, and has a particle diameter of 0.2 μm to 8 μm.

9. The matte coating composition of claim 6, wherein the silicone mixed powder includes organic particles having silicone resin powder protrusions formed on a surface thereof.

10. The matte coating composition of claim 6, wherein the silicone mixed powder is formed by coating the organic particles with the silicone resin powder, and has a particle diameter of 0.5 μm to 20 μm.

11. The matte coating composition of claim 1, wherein the binder resin is one or more formed from the group consisting of a water-dispersible polyurethane resin, an acrylic resin, a polyester resin, and a combination thereof.

12. An interior material for a vehicle comprising:
a base layer; and
a matte coating layer formed of the matte coating composition of claim 1.

13. The interior material for a vehicle of claim 12, wherein a glossiness of the matte coating layer at 60 degrees is 2 or less, the glossiness being measured by a BYK (Micro-TRI-gloss) gloss meter.

14. The interior material for a vehicle of claim 12, wherein the matte coating layer has a standard deviation of a surface friction coefficient of 0.5 or less.

15. The interior material for a vehicle of claim 12, wherein the base layer includes one or more selected from the group consisting of a polyvinyl chloride resin, a polyurethane resin, a polylactic acid resin, and a combination thereof.
